(19) United States
(12) Patent Application Publication
(10) Pub. No.: US 2018/0192350 A1
(43) Pub. Date: Jul. 5, 2018

(54) IN-VEHICLE WIRELESS DATA EXCHANGE SYSTEM AND CONTROLLING METHOD THEREOF

(71) Applicants: Hyundai Motor Company, Seoul (KR); Kia Motors Corporation, Seoul (KR)

(72) Inventors: Joon Young KIM, Seoul (KR); Ju Won KIM, Anyang-si (KR); Sung Hoi PARK, Seoul (KR)

(73) Assignees: Hyundai Motor Company, Seoul (KR); Kia Motors Corporation, Seoul (KR)

(21) Appl. No.: 15/804,985

(22) Filed: Nov. 6, 2017

(30) Foreign Application Priority Data
Dec. 29, 2016 (KR) 10-2016-0182259

(51) Int. Cl. H04W 40/12

(52) U.S. Cl. CPC H04W 40/12; H04W 84/12

(57) ABSTRACT

A data exchanging method of a vehicle device configured for supporting a plurality of protocols may include receiving a packet of an external device through at least one of a plurality of communication modules corresponding to the plurality of protocols, respectively, determining data to be transmitted to the external device and a communication module to be used to transmit the data among the plurality of communication modules, based on information related to the received packet, and transmitting the data to the external device through the determined communication module.

The present application claims priority to Korean Patent Application No. 10-2016-0182259, filed on Dec. 29, 2016, the entire contents of which is incorporated herein for all purposes by this reference.

### BACKGROUND OF THE INVENTION

### Field of the Invention

The present invention relates to an in-vehicle wireless data exchange system and a controlling method thereof, and more particularly, to an in-vehicle wireless data exchange system and a controlling method thereof, for more effectively exchanging data by wireless communication devices for supporting a plurality of protocols using similar frequency bandwidths in consideration of a vehicle environment.

### Discussion of Related Art

The Internet of things (IoT) refers to a physical network via which an object including a detector and a communication chip installed therein automatically transmits and receives data in real time without human intervention. In an IoT environment, devices (objects) with a detector or a communication function may be connected via the Internet to collect surrounding information and may transmit and receive data to and from other devices to make an appropriate decision.

That is, the IoT refers to communication between objects that use wireless and wired networks based on a detector and chip attached to an IoT device and is based on Bluetooth, near field communication, (NFC), detector data, a network, and the like.

In particular, the IoT is capable of manipulating residential electronic products using a smartphone out of doors and, thus, recently, the IoT has attracted much attention and combination with vehicles has actively attempted along with a concept of a smart car and a connected car.

Due to establishment of various wireless communication standards along with growth with geometric progression in the number of IoT devices, the possibility that multiple devices simultaneously use a frequency band of 900 MHz when using the frequency band is increased. Accordingly, particularly, when detectors in a vehicle are implemented with an IoT device, the worry about data loss due to interference is also increased in a vehicle wireless communication environment. To prevent data loss in vehicles and to reinforce wireless communication connectivity, there is a need for a method of more effectively using a limited frequency band.

The information disclosed in the present Background of the Invention section is only for enhancement of understanding of the general background of the invention and may not be taken as an acknowledgement or any form of suggestion that the present information forms the related art already known to a person skilled in the art.

### BRIEF SUMMARY

Various aspects of the present invention are directed to providing an in-vehicle wireless data exchange system and a controlling method thereof, for more effectively exchanging radio data in a vehicle environment.

Various aspects of the present invention are directed to providing an in-vehicle wireless data exchange system and a controlling method thereof, for more effective communication when multiple devices support all different wireless communication protocols in a vehicle environment.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure pointed out in the written description and claims hereof as well as the appended drawings.

To achieve these objects and other advantages and in accordance for the invention, as embodied and broadly described herein, a data exchanging method of a vehicle device configured for supporting a plurality of protocols includes receiving a packet of an external device through at least one of a plurality of communication modules corresponding to the plurality of protocols, respectively, determining data to be transmitted to the external device and a communication module to be used to transmit the data among the plurality of communication modules, based on information related to the received packet, and transmitting the data to the external device through the determined communication module.

In another aspect of the present invention, a communication device configured for supporting a plurality of protocols includes a plurality of communication modules corresponding to the plurality of protocols, respectively, and a controller configured to, upon receiving a packet of an external device through at least one of the plurality of communication modules, determine data to be transmitted to the external device and a communication module to be used to transmit the data among the plurality of communication modules, based on information related to the received packet, and transmit the data to the external device through the determined communication module.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a diagram illustrating an exemplary embodiment in which communication between wireless communication devices is performed according to embodiment of the present invention;

FIG. 2 is a flowchart showing an exemplary embodiment of a procedure of exchanging data between devices according to an exemplary embodiment of the present invention;

FIG. 3 is a flowchart showing another exemplary embodiment of a procedure of exchanging data between devices according to an exemplary embodiment of the present invention;

FIG. 4 is a diagram for explanation of a relative location between devices according to an exemplary embodiment of the present invention;

FIG. 5 is a diagram illustrating a procedure of checking a communication state and performing reconnection according to an exemplary embodiment of the present invention; and

FIG. 6 is a block diagram illustrating an exemplary embodiment of an audio/video/navigation (AVN) system according to an exemplary embodiment of the present invention.

It may be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particularly intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Throughout the present specification, unless explicitly described to the contrary, the word “comprise” and variations such as “comprises” or “comprising”, will be understood to imply the inclusion of stated elements but not the exclusion of any other elements. In addition, the same reference numbers will be used throughout the drawings to refer to the same or like parts.

Various embodiments of the present invention is directed to providing a method of applying sensor-based standard protocols including Zigbee and Z-wave and new standard protocols for the Internet of things (IoT) device including IEEE 802.11ah and selectively applying standards used in transmission by each device in response to diversified vehicle environments to robustly exchange data with respect to a change in vehicle environment.

According to the exemplary embodiments of the present invention, it is assumed that two or more wireless communication protocols are supported when devices, which are disposed in a vehicle and wirelessly exchange data, wirelessly exchange data.

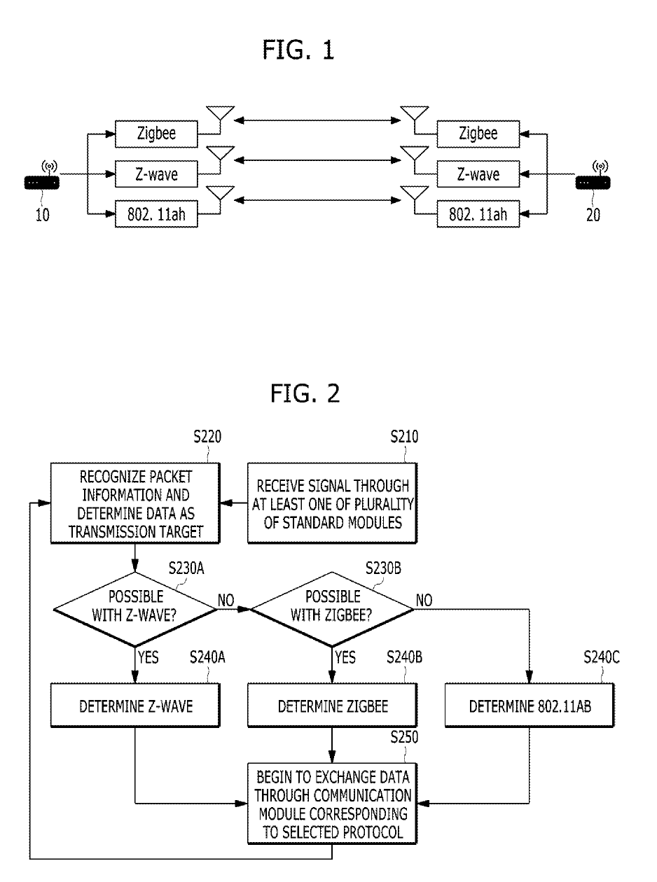

Such a communication concept between devices will be described below with reference to FIG. 1.

FIG. 1 is a diagram illustrating an exemplary embodiment in which communication between wireless communication devices is performed according to embodiment of the present invention.

Referring to FIG. 1, both a first device 10 and a second device 20 support three communication protocols of Zigbee, Z-wave, and 802.11ab. Here, support of the three wireless communication protocols may refer to simultaneous communication according to two or more wireless protocols. For example, the first device 10 and the second device 20 may simultaneously exchange data according to the 802.11ah protocol while exchanging data according to the Zigbee protocol. As another example, while not being connected to the second device 20, the first device 10 may simultaneously or sequentially search for peripheral devices according to the three protocols to discover the second device 20 and to perform a connection request according to one or more protocols.

In the instant case, as a hardware configuration, each of the first and second devices 10 and 20 may include both a modem and an antenna which separately operate according to each of the three protocols or one modem and one antenna may be implemented to perform communication according to two or more communication protocols.

Needless to say, these protocols are exemplary and, thus, it would be obvious to one of ordinary skill in the art that the protocols are not limited to a particular protocol as long as communication between devices is possible.

Here, each of the first device 10 and the second device 20 may be a detector included in a vehicle or a controller. For example, both the first device 10 and the second device 20 may be a detector, one of the first device 10 and the second device 20 may be a detector and the other may be a controller, or both the first device 10 and the second device 20 may be a controller. In addition, while communicating with the second device 20 through at least one protocol of the three protocols, the first device 10 may also simultaneously communicate with a third device through a protocol which is not used in communication with the second device 20.

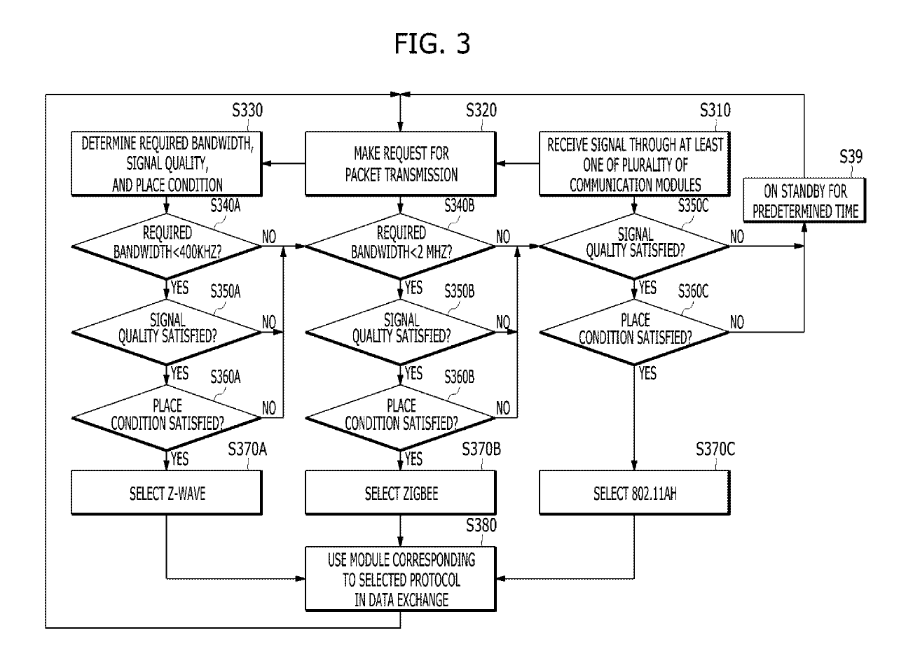

Hereinafter, a procedure of exchanging data between two devices will be described with reference to FIG. 2 and FIG. 3.

FIG. 2 is a flowchart showing an exemplary embodiment of a procedure of exchanging data between devices according to an exemplary embodiment of the present invention.

Referring to FIG. 2, first, a device (hereinafter, referred to as a “first device” for convenience) which is on standby to connect another device may search for and receive a signal of a device (hereinafter, referred to as a “second device” for convenience) that makes a request for connection to the first device to establish a data communication path with the second device through any one of a plurality of communication standard protocols (here, the protocols are assumed to be Z-wave, Zigbee, and 802.11ah) (S210). To the present end, the first device may activate all of three communication modules that are in charge of the three protocols, respectively, to search for the signal of the second device.

When retrieving the signal of the second device, the first device may determine data as a transmission target and a bandwidth required to transmit the data based on packet information received from the second device (S220). Here, the received packet information may include information for identifying a type of data for which the second device makes a request to the first device.

Accordingly, the first device may determine whether a bandwidth of Z-wave is sufficient to transmit data (S230A) or, otherwise, whether a bandwidth of Zigbee is sufficient to transmit data (S230B). For example, when the Z-wave protocol supports a bandwidth of 300 or 400 kHz, the Zigbee protocol supports a bandwidth of 2 MHz, and the 802.11ah supports a bandwidth of 1 to 40 MHz, when a bandwidth of 300 kHz is sufficient, Z-wave communication may be determined (S240A) and when a bandwidth of 300 kHz is insufficient but a bandwidth of 2 MHz is sufficient, Zigbee communication may be determined (S240B). When a bandwidth is not determined to be satisfied with Zigbee communication, the first device may select 802.11ah communication (S240C).

When the first device selects the 802.11ah communication, 802.11ah is configured for using various bandwidths over 2, 4, 8, and 16 MHz and, thus, the bandwidths may be variably applied depending on a data transmission rate.

Upon completing selection of a communication protocol, the first device may verify a channel state through a communication module corresponding to the corresponding protocol, select an optimal channel, and begin to transmit data to the second device (S250). Here, the channel state may be checked via channel scanning or link quality indicator in each communication module and when there is a channel used by another device except for the first device and the second device, the corresponding channel may not be selected.

When information on a data amount in a packet or a data transmission rating is changed in response to change in data transmitting and receiving channel, the first device may return operation S230A and perform a corresponding procedure.

In the aforementioned data exchanging procedure described with reference to FIG. 2, signal quality and a location condition may be further considered to select a communication protocol.

This will be described below with reference to FIG. 3.

FIG. 3 is a flowchart showing another exemplary embodiment of a procedure of exchanging data between devices according to an exemplary embodiment of the present invention.

Referring to FIG. 3, the first device may search for and receive a signal of the second device that makes a request for connection to the first device to establish a data communication path with the second device through any one of a plurality of communication standard protocols (here, the protocols are assumed to be Z-wave, Zigbee, and 802.11ah) (S310). To the present end, the first device may activate all of three communication modules that are in charge of the three protocols, respectively, to search for the signal of the second device.

When retrieving the signal of the second device, the first device may make a request for packet transmission to the second device (S320). Upon receiving a packet from the second device in response to the request, the first device may determine signal quality and a location condition along with data as a transmission target and a bandwidth required to transmit the data based on information related to the received packet (S330).

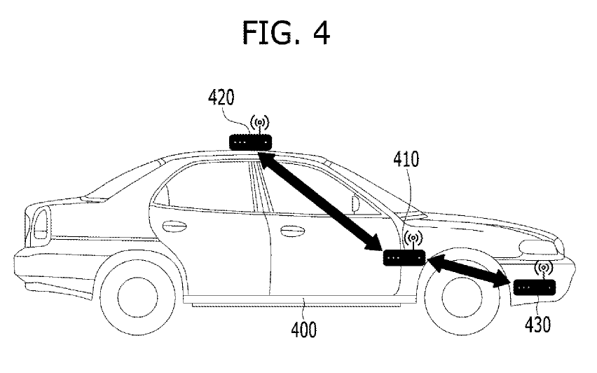

Here, the received packet information may include information for identifying a type of data for which the second device makes a request to the first device and location information related to a corresponding device and, in the packet receiving procedure as well as the aforementioned signal searching procedure, signal quality of each communication protocol of the second device may also be measured. In addition, location information related to a device may indicate a location of a vehicle (e.g., a front windshield, a roof, and a front bumper), in which a corresponding device is disposed, and may be formed in a unique identifier for each location or in a two-dimensional (2D) or three-dimensional (3D) coordinate of a predetermined reference location. The location information related to a device will be described below with reference to FIG. 4.

Accordingly, the first device may determine whether a bandwidth of 400 kHz is sufficient to transmit data (S340A) or, otherwise, whether a bandwidth of 2 MHz is sufficient to transmit data (S340B).

When a bandwidth of 400 kHz is sufficient, whether signal quality (e.g., RSSI) defined in the Z-wave protocol is satisfied (S350A) and whether a location condition is satisfied (S360A) may be sequentially determined and, when both of the two are satisfied, the Z-wave protocol may be selected (S370A).

Similarly, when a bandwidth of 400 kHz is not sufficient but a bandwidth of 2 MHz is sufficient, whether signal quality (e.g., RSSI) defined in the Zigbee protocol is satisfied (S350B) and whether a location condition is satisfied (S360B) may be sequentially determined and, when both of the two are satisfied, the Zigbee protocol may be selected (S370B).

In addition, when a bandwidth greater than 2 MHz is required, whether signal quality (e.g., RSSI) defined in the 802.11ah protocol is satisfied (S350C) and whether a location condition is satisfied (S360C) may be sequentially determined and, when both of the two are satisfied, the 802.11ah protocol may be selected (S370C).

Whether a bandwidth of Zigbee is sufficient (S230B) may be determined. For example, when the Z-wave protocol supports a bandwidth of 300 or 400 kHz, the Zigbee protocol supports a bandwidth of 2 MHz, and the 802.11ah supports a bandwidth of 1 to 40 MHz, when a bandwidth of 300 kHz is sufficient, Z-wave communication may be determined (S240A), and when a bandwidth of 300 kHz is not sufficient but a bandwidth of 2 MHz is sufficient, Zigbee communication may be determined (S240B). Upon determining that a bandwidth is not satisfied by Zigbee communication, the first device may select 802.11ah communication (S240C).

Upon completing selection of a communication protocol, the first device may verify a channel state through a communication module corresponding to the corresponding protocol, select an optimal channel, and begin to transmit data to the second device (S380). Here, the channel state may be checked via channel scanning or link quality indicator in each communication module and when there is a channel used by another device except for the first device and the second device, the corresponding channel may not be selected.

FIG. 4 is a diagram for explanation of a relative location between devices according to an exemplary embodiment of the present invention.

In FIG. 4, a vehicle 400 is assumed to include an audio/video/navigation (AVN) controller 410 disposed in a center fascia, a roof detector 420 disposed at a roof, and a front camera 430 disposed in a front bumper. For example, to acquire a front image by an AVN controller 410 during vehicle stop in the present situation, when the AVN controller 410 may make a request for image transmissions to the camera 430 through a packet, when there is no worry about interference with the roof detector 420 which is disposed at a roof in terms of a location and RSSI is sufficiently high during communication with the AVN controller 410, the camera 430 may select the 802.11ah protocol with a wide bandwidth and transmit a camera image to the AVN controller 410 to transmit an image.

As another example, it is assumed that, in a driving situation, the roof detector 420 transmits only a relatively simple detecting value corresponding to 1 Mbps to the AVN controller 410, the camera 430 intends to transmit only a control signal corresponding to 20 kbps instead of a captured image to the AVN controller 410, and there is no worry about interference between the roof detector 420 and the camera 430 in terms of locations. In the instant case, the AVN controller 410 may receive data from the roof detector 420 according to the Zigbee protocol and receive data from the camera 430 according to the Z-Wave protocol.

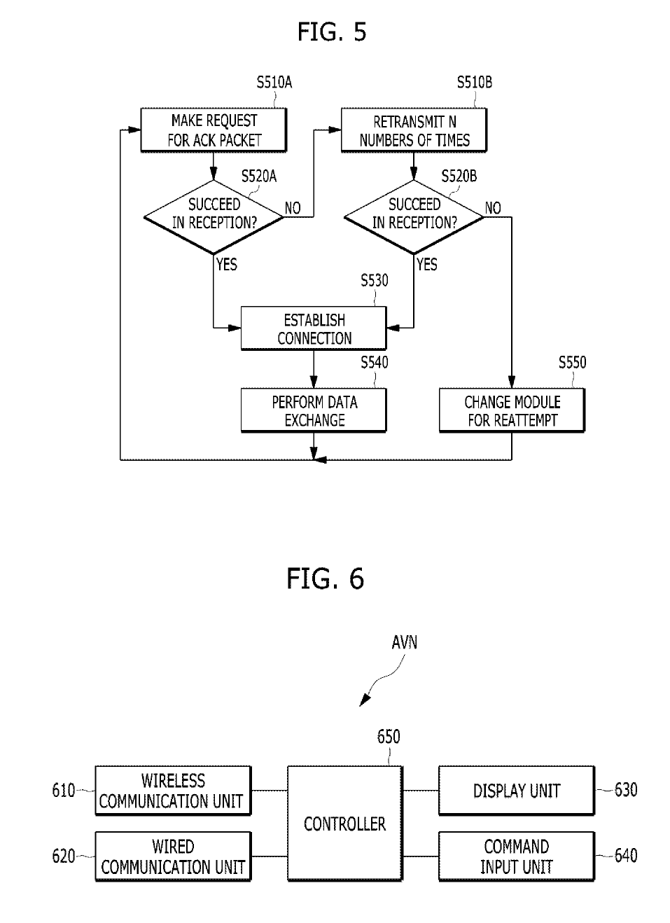

FIG. 5 is a diagram illustrating a procedure of checking a communication state and performing reconnection according to an exemplary embodiment of the present invention.

Referring to FIG. 5, first, a device that intends to verify a communication state may make a request to an ACK packet to an opposite device (S510A). In response to the request, when the ACK packet is successfully received from the opposite device (S520A), the corresponding device may determine that connection is effectively established (S530) and normally perform data exchange with the opposite device (S540). As such, the corresponding device may repeatedly perform operation S510A periodically or when connection with the opposite device is required to be checked.

On the other hand, when reception of the ACK packet fails, a request for an ACK packet with respect to the opposite device may be retransmitted a predetermined number of times (N) (S510B), and when the ACK packet is not received even after retransmission is performed N number of times, the corresponding device may change a determined module to a module according to a different protocol from a communication protocol used in current connection and reattempt the request for the ACK packet to reattempt connection (S550).

Hereinafter, as an exemplary embodiment of a device configured for supporting a plurality of protocols to implement the aforementioned embodiments, a structure of a vehicle audio/video/navigation (AVN) system (or an AVN controller) will be described.

FIG. 6 is a block diagram illustrating an exemplary embodiment of an AVN system according to an exemplary embodiment of the present invention.

Referring to FIG. 6, the AVN system of a vehicle may include a wireless communication device 610 which is connected to an external device including another controller or a detector to exchange data, a wired communication device 620 for exchanging a signal with other controllers of a vehicle including a speed detector, a transmission controller, a motor controller, and an engine controller, for providing information for determining a vehicle driving state, a display device 630 for displaying a list of various functions or an execution image and a navigation image, a command input device 640 for receiving a command from a driver through a touchpad, a key button, or the like, and a controller 650 for controlling the aforementioned components and performing determination and determination required to perform the present embodiment.

Here, the wireless communication device 610 may include a communication module corresponding to each protocol to simultaneously exchange data with an external device according to two or more protocols and one module may be in charge of only one protocol or one muddle may be in charge of two or more protocols.

The controller 650 may control the wireless communication device 610 to perform wireless connection with peripheral devices and control an overall procedure of packet transmission request via the aforementioned device search, communication module selection via determination of a required bandwidth, signal quality, a place condition, and the like in response to packet reception, and data exchange procedure using the selected module.

Needless to say, the components of FIG. 6 are exemplary and, thus, it would be obvious to one of ordinary skill in the art that greater or fewer components may be included as necessary. For example, a wireless communication device may be included in a controller present outside the AVN system and may further include a sound output device configured for outputting a guidance voice, warning horn, and the like of multimedia or a navigation player. In addition, a data exchange function using the plurality of protocols may be distributed and implemented by one or more other controllers and, in the instant case, components for performing functions according to an exemplary embodiment of the present invention may be further included in addition to the components of FIG. 6. In addition, when a device configured for supporting a plurality of protocols is implemented in a form of a detector, a detector may be further included in addition to components corresponding to the aforementioned communication device and controller.

The aforementioned present invention can also be embodied as computer readable code stored on a computer readable recording medium. The computer readable recording medium is any data storage device that can store data which can thereafter be read by a computer. Exemplary embodiments of the computer readable recording medium include a hard disk drive (HDD), a solid state drive (SSD), a silicon disc drive (SDD), read-only memory (ROM), random-access memory (RAM), CD-ROM, magnetic tapes, floppy disks, optical data storage devices, carrier wave (e.g., transmission via the Internet), etc.

According to the aforementioned at least one exemplary embodiment of the present invention, wireless data exchange may be more effectively performed in a vehicle environment.

data exchange may be performed through a most appropriate protocol to a current situation among different wireless communication protocols supported by respective devices, effectively alleviating an issue in terms of insufficient wireless resources due to simultaneous operations of a plurality of devices in a relatively narrow space.

For convenience in explanation and accurate definition in the appended claims, the terms “upper”, “lower”, “internal”, “outer”, “up”, “down”, “upper”, “lower”, “upwards”, “downwards”, “front”, “rear”, “back”, “inside”, “outside”, “inwardly”, “outwardly”, “internal”, “external”, “internal”, “outer”, “forwards”, and “backwards” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described to explain certain principles of the invention and their practical application, to enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A data exchanging method of a vehicle device for supporting a plurality of protocols, the method comprising:
receiving a packet of an external device through at least one of a plurality of communication modules corresponding to the plurality of protocols, respectively;
determining data to be transmitted to the external device and a communication module to be used to transmit the data among the plurality of communication modules, based on information related to the received packet; and
transmitting the data to the external device through the determined communication module.

2. The method according to claim 1, wherein the information related to the received packet includes at least one of signal quality information, data information requested by the external device, and place information related to the external device.

3. The method according to claim 2, wherein the determining includes determining the data to be transmitted to the external device based on the data information requested by the external device.

4. The method according to claim 2, wherein the determining includes:
determining a required bandwidth based on the determined data; and
determining a communication module corresponding to a protocol satisfying the determined required bandwidth among the plurality of communication modules.

5. The method according to claim 2, wherein the determining includes determining whether the signal quality information satisfies minimum signal quality defined in each of the plurality of protocols.

6. The method according to claim 1, wherein the plurality of protocols comprise at least two of Z-wave, Zigbee, and 802.11ah.

7. The method according to claim 1, further including:
making a request for a predetermined packet to the external device; and
determining whether the predetermined packet is received.

8. The method according to claim 7, further including:
when the predetermined packet is received, maintaining connection with the external device; and
when the predetermined packet is not received, retransmitting a request for the predetermined packet to the external device a predetermined number of times.

9. The method according to claim 8, further including:
when the predetermined packet is not received after the request for the predetermined packet is retransmitted the predetermined number of times, changing the determined communication module to a remaining one of the plurality of communication modules; and
making a request for the predetermined packet to the external device through the changed communication module.

10. A computer readable recording medium having recorded thereon a program for executing the method according to claim 1.

11. A communication device for supporting a plurality of protocols, the communication device comprising:
a plurality of communication modules corresponding to the plurality of protocols, respectively; and
a controller configured to, upon receiving a packet of an external device through at least one of the plurality of communication modules, determine data to be transmitted to the external device and a communication module to be used to transmit the data among the plurality of communication modules, based on information related to the received packet, and transmit the data to the external device through the determined communication module.

12. The communication device according to claim 11, wherein the information related to the received packet includes at least one of signal quality information, data information requested by the external device, and place information related to the external device.

13. The communication device according to claim 12, wherein the controller is configured to determine the data to be transmitted to the external device based on the data information requested by the external device.

14. The communication device according to claim 12, wherein the controller is configured to determine a required bandwidth based on the determined data and is configured to determine a communication module corresponding to a protocol satisfying the determined required bandwidth among the plurality of communication modules.

15. The communication device according to claim 12, wherein the controller is configured to determine whether the signal quality information satisfies minimum signal quality defined in each of the plurality of protocols.

16. The communication device according to claim 11, wherein the plurality of protocols comprise at least two of Z-wave, Zigbee, and 802.11ah.

17. The communication device according to claim 11, wherein the controller makes a request for a predetermined packet to the external device and is configured to determine whether the predetermined packet is received.

18. The communication device according to claim 17, wherein the controller is configured to maintain connection with the external device when the predetermined packet is received and retransmits a request for the predetermined packet to the external device a predetermined number of times when the predetermined packet is not received.

19. The communication device according to claim 18, wherein the controller is configured to change the determined communication module to a remaining one of the plurality of communication modules when the predetermined packet is not received after the request for the predetermined packet is retransmitted the predetermined number of times and makes a request for the predetermined packet to the external device through the changed communication module.
